(19) United States
(12) Patent Application Publication
(10) Pub. No.: US 2006/0274606 A1
(43) Pub. Date: Dec. 7, 2006

(54) Particle-based time indicator and method for its use

(76) Inventor: Wesley Fields, Los Gatos, CA (US)

Correspondence Address: MICHAEL A. GUTH, 2-2905 EAST CLIFF DRIVE, SANTA CRUZ, CA, 95062, US

(21) Appl. No.: 11/144,864

(22) Filed: Jun. 3, 2005

(51) Int. Cl. G04F 10/00; G04F 8/00

(52) U.S. Cl. 368/114

(57) ABSTRACT

A particle-based time indicator that indicates the passage of time through the settling of particles suspended in a liquid. The indicator may consist of a container of fluid and particles of different ranges of sizes. The container may have one or more timing marks for viewing. In some embodiments, a medication bottle including a particle-based timer as described above

### BACKGROUND OF THE INVENTION

1. Field of Invention

The present invention related generally to the field of time indicators, and more specifically to a passive device for time indication using particles suspended in liquid.

2. Description of Related Art

Numerous devices are known which provide a visual indication of a pre-arranged amount of time. Such time indicators are useful, for example, when attached to perishable items for indicating the length of time the items have been on the wholesaler's or retailer's shelf. Thus, foods and other perishable items such as photographic materials can be provided with indicators which evidence a visual change after being activated, and after the passage of a predetermined amount of time.

U.S. Pat. No. 4,212,153 to Kydonieus et al. describes a laminated time indicator including a two-layer rear reservoir part. The front indicator part has an indicator layer with an outer display surface and an inner surface having an adhesive layer thereon. For example, a pressure-sensitive adhesive coated onto an opaque barrier such as vinyl. The rear reservoir part has a dye or ink film layer and a support card layer. When assembled, the front part is placed on the rear part with the ink film layer forming an assembly joint with the adhesive layer. The dye or ink dissolves in the adhesive. After a period of time, the ink migrates from the ink film layer through the adhesive layer and through an indicator layer to be displayed on the outer surface.

U.S. Pat. No. 3,520,124 to Meyers, describes a parked car time indicator including a first sheet having a first reactant and a second sheet having a second reactant and a release sheet which is peeled away to permit contact of the first sheet with the second sheet to start a reaction over a selective time interval terminating with a color change of the reactants.

A shortcoming of most if not all of these types of devices is that the device can only be used once and must thereafter be replaced.

Pill bottle containers with mechanical devices that can be set to indicate that a dosage has been taken, or when a dosage should next be taken, are numerous in the prior art. A typical approach utilizes rotating rings that have day and time indicia that can be rotated and set to indicate when the next dose is to be taken. A disadvantage of these devices is that they do not actually indicate the lapsing of any time but instead only notate at what time the next dosage should be taken. This notation does not have meaning without the consultation of another timepiece.

What is called for is a passive device that indicates the passage of time and that is re-usable.

### BRIEF SUMMARY OF THE INVENTION

A particle-based time indicator that indicates the passage of time through the settling of particles suspended in a liquid. The indicator may consist of a container of fluid and particles of different ranges of sizes. The container may have one or more timing marks for viewing. In some embodiments, a medication bottle including a particle-based timer as described above.

### BRIEF DESCRIPTION OF THE DRAWINGS

FIG. 1 is a front view of a particle-based time indicator according to some embodiments of the present invention.

FIG. 2 is a front view of a particle-based time indicator shortly after suspension of the particles according to some embodiments of the present invention.

FIG. 3 is a front view of a particle-based time indicator a time after suspension of the particles according to some embodiments of the present invention.

FIG. 4 is a front view of a particle-based time indicator a longer time after suspension of the particles according to some embodiments of the present invention.

FIG. 5 is a top-front perspective view of a particle-based time indicator according to some embodiments of the present invention.

FIG. 6 is a front view of a particle-based time indicator showing timing marks according to some embodiments of the present invention.

FIG. 7 is a front view of a particle-based time indicator with timing marks after suspension of the particles according to some embodiments of the present invention.

FIG. 8 is a front view of a particle-based time indicator with timing marks after suspension of the particles according to some embodiments of the present invention.

FIG. 9 is a perspective view of a medication container with a particle-based timing indicator according to some embodiments of the present invention.

FIG. 10 is a perspective view of an aquarium with a particle-based timing indicator according to some embodiments of the present invention.

FIG. 11 is a perspective view of a particle-based timing indicator according to some embodiments of the present invention.

FIG. 12 is a photograph of a particle based timing indicator according to some embodiments of the present invention.

FIG. 13 is a photograph of a particle based timing indicator according to some embodiments of the present invention.

FIG. 14 is a photograph of a particle based timing indicator according to some embodiments of the present invention.

FIG. 15 is a photograph of a particle based timing indicator according to some embodiments of the present invention.

FIG. 16 is a photograph of a particle based timing indicator according to some embodiments of the present invention.

FIG. 17 is a photograph of a particle based timing indicator according to some embodiments of the present invention.

FIG. 18 is a photograph of a particle based timing indicator according to some embodiments of the present invention.

FIG. 19 is a photograph of a particle based timing indicator according to some embodiments of the present invention.

### DETAILED DESCRIPTION

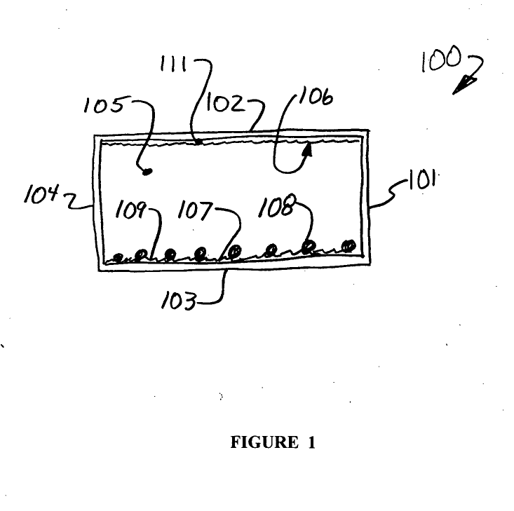

In some embodiments of the present invention, as seen in FIG. 1, a particle-based timing apparatus 100 has an enclosed container 101 containing a volume of fluid 105. In some embodiments, the fluid is isopropyl alcohol. The enclosed container 101 has a top 102, and bottom 103, and a side portion 104. The volume of fluid 105 has a top surface 106 which leaves a small air space 111 in some embodiments. Within the enclosed container 101 are a volume of particles 107. In some embodiments, the volume of particles 107 consists of a volume of a first size range of particles 108, and a volume of a second size range of particles 109. In some embodiments, the first size range of particles is a larger size range consisting of particles of approximately 0.050 to 0.010 inches in cross section. The second size range of particles may consist of fine grain particles of much smaller size. In some embodiments, the volume of the first size range of particles is ¼ teaspoon. In some embodiments, the volume of the second size range of particles is ¼ teaspoon. In some embodiments, the volume of the container is 2 fluid ounces.

In some embodiments, the two size ranges of particles facilitate the suspension of the fine grain particles. The operation of the particle-based timing apparatus 100 depends upon the suspension of the smaller, dust-like particles. These particles suspend in the fluid and slowly dissipate out to the bottom. The dissipation occurs from the top surface 106 of the fluid down towards the bottom over time. The suspension of the smaller, second size range of particles 109 is facilitated by the vigorous stirring action caused by the larger, first size range of particles 108 when the apparatus 100 is disturbed, especially by being turned over and then placed again right side up. The larger particles cause much more disruption to the fluid and stir up the smaller particles leading to more complete and more even suspension of the smaller particles. In some embodiments, the larger particles are used not as part of the later settling suspension but as a stirring agent for the smaller particles.

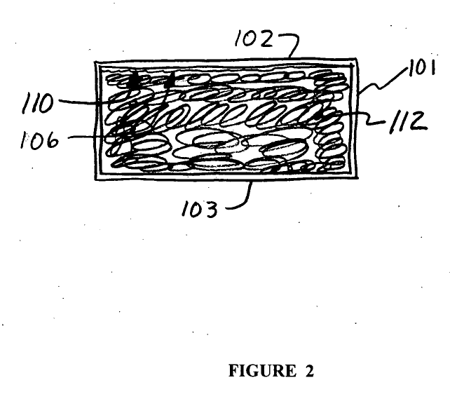

The particle-based timing apparatus 100 is shown in FIG. 2 in a condition immediately after the suspension of the particles, as by having turned the apparatus over and then resetting it on its bottom. An opaque particle suspension area 112 is shown which is in contrast to the prior clear fluid which was seen throughout the enclosed container 101 prior to the suspension of the particles. The upper boundary 110 of the particle suspension area 112 is the boundary between the opaque particle suspension area 112 and the clear fluid. In the case where the particles have just been suspended without the passage of much time, the upper boundary 110 of the particle suspension area 112 is coincident with the top surface 106 of the volume of fluid 105. In some embodiments, the larger particles will come to rest on the bottom 103 of the enclosed container 101 almost immediately after the enclosed container 101 has been reset on its bottom.

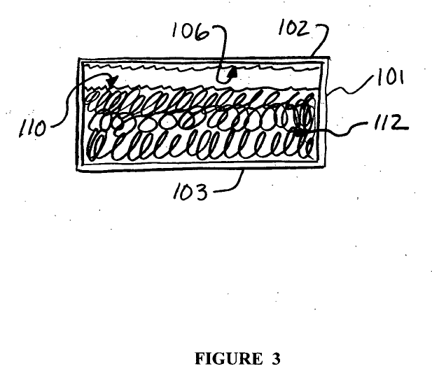

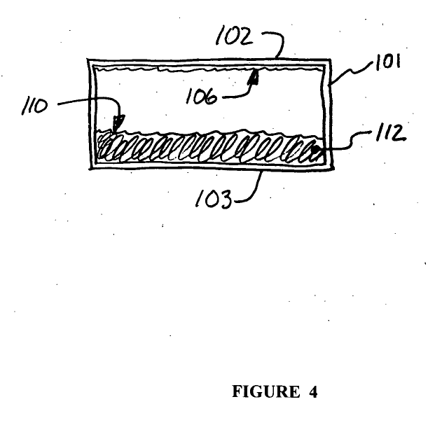

FIGS. 3 and 4 illustrate the timing aspect of the particle-based timing apparatus 100 according to some embodiments of the present invention. As seen in FIG. 3, the opaque particle suspension area 112 is not as large as it was at the earlier time. With the passage of time, the smaller particles have settled out in an orderly fashion such that the upper boundary 110 of the particle suspension area 112 is now lower than the top surface 106 of the volume of fluid. The area above the upper boundary 110 of the opaque particle suspension area 112 is again clear, in contrast to the area below the upper boundary 110 of the particle suspension area 112. FIG. 4 illustrates the particle-based timing apparatus 100 after another segment of time has elapsed from the time frame as illustrated in FIG. 3. The upper boundary 110 of the particle suspension area 112 is now even lower than at the previous time period that had been illustrated in FIG. 3. This procession of the lowering of the upper boundary 110 of the particle suspension area 112 will continue over time until the entire fluid area is once again clear.

In some embodiments, the fluid used is isopropyl alcohol. In some embodiments, the particles are silica sand. The use of two size ranges of silica sand along with the isopropyl alcohol yields a suspension that will settle out in an orderly fashion with a defined upper boundary of the opaque particle suspension area. The larger particles enhance the mixing and suspension of the smaller particles. This upper boundary will lower with the passage of time until ultimately all of the suspended particles have settled out. Depending upon the volume of fluid used and the volume of fine particles used, the settling rate will vary. Combinations of fluid and particle quantity may be selected to allow for settling to occur at 0.1 inches per hour or other rates. Other fluids may also be used, and fluids may be selected that have different settling rates. Factors affecting the settling rate include the fluid density, the particle density, and the particle size.

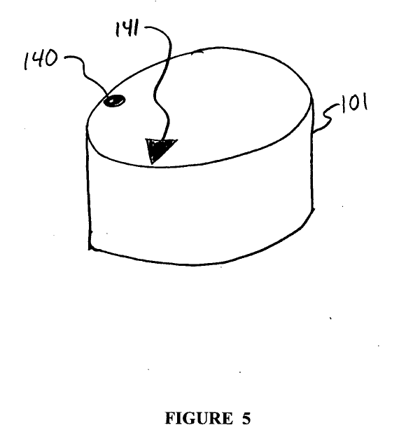

FIG. 5 illustrates a particle-based time indicator with a viewing marker 141. The viewing marker 141 signifies the point on the side of the indicator through which to look, especially in embodiments with timing marks. The seal 140 may be used to seal the container after the insertion of the particles and the fluid. In some embodiments, the seal may be adhesively fastened to the container. In some embodiments, the container may be sealed shut after the insertion of the liquid and the particles by the bonding on to the container of the top or bottom of the container.

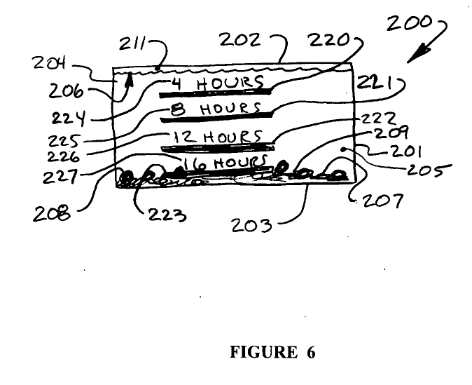

FIG. 6 illustrates a particle-based timing indicator 200 according to some embodiments of the present invention. A particle-based timing apparatus 200 has an enclosed container 201 containing a volume of fluid 205. In some embodiments, the fluid is isopropyl alcohol. The enclosed container 201 has a top 202, and bottom 203, and a side portion 204. The volume of fluid 205 has a top surface 206 which leaves a small air space 211 in some embodiments. Within the enclosed container 201 are a volume of particles 207. In some embodiments, the volume of particles 207 consists of a volume of a first size range of particles 208, and a volume of a second size range of particles 209. In some embodiments, the first size range of particles is a larger size range consisting of particles of approximately 0.050 to 0.010 inches in cross section. The second size range of particles may consist of fine grain particles of much smaller size.

The particle-based timing indicator 200 has a plurality of timing marks 220, 221, 222, 223 marked along its side portion 204. In some embodiments, the timing marks 204 will be marked along the outside of the container 201 such that the marks are viewed and meant to be looked through, over, and around into the liquid within the container. In some embodiments, the marks 204 will be marked along the outside of the container in reverse print such that they are meant to be viewed through the liquid. In some such embodiments, the timing marks may be painted over or otherwise obscured from their backside so that the only viewing angle to the marks is through the liquid. In some embodiments, a single timing mark may be used.

A plurality of time indicators 224, 225, 226, 227 may be associated with the plurality of timing marks 220, 221, 222, 223. The plurality of time indicators 224, 225, 226, 227 display the amount of time that has passed since the suspension of the particles. As the particles settle out, more of the timing marks and their associated time indicators become visible, and indicate the amount of time that has passed since the particles were suspended.

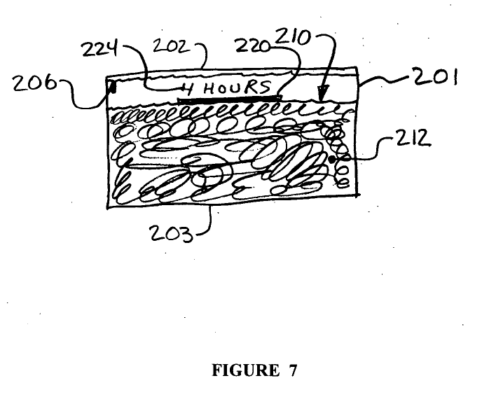

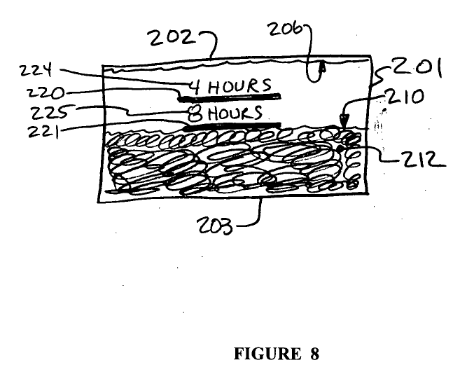

FIGS. 7 and 8 illustrate the particle-based time indicator 200 at two time intervals subsequent to the suspension of the particles. The particles may be suspended, and the time indicator triggered (or started), by the turning over and then resetting of the indicator 200. As seen in FIG. 7, the opaque particle suspension area 212 has settled over time such that the upper boundary 210 of the opaque particle suspension area 212 is lower than the top surface 206 of the volume of fluid 205. In this example, the timing mark 220 for the time indicator 224 signifying 4 hours is visible, indicating that 4 hours has past since the triggering of the time indicator by the suspension of the particles. FIG. 8 illustrates the time indicator at another point later in time. The upper boundary 210 of the opaque particle suspension area 212 is lower than seen at the 4 hour mark. The timing mark 221 for the time indicator 225 signifying 8 hurs is now visible. This is the case after 8 hours has elapsed since the triggering of the indicator.

In some embodiments, the plurality of time indicators 224, 225, 226, 227 and their associated plurality of timing marks 220, 221, 222, 223 may be placed on the outside of the container 201, such that the viewer looks through the marks and lines up the upper boundary 210 of the opaque particle suspension area 212 with marks on the front of the container. In other embodiments, as seen in FIGS. 7 and 8, the plurality of time indicators 224, 225, 226, 227 and their associated plurality of timing marks 220, 221, 222, 223 are placed at the back of the container and are viewed through the liquid area. In such embodiments, the timing marks and timing indicators for times that have not yet passed are obscured by the opacity of the liquid.

In some embodiments, two different size ranges of the fine grain particles may be used in addition to the larger particles that are used to assist in the suspension of the fine grain particles. In some embodiments, the two different size ranges of fine grain particles may be of different colors. The color of the liquid suspension may be a mix of the two colors immediately after the suspension of the fine grain particles. As one of the colors of fine grain particles settles out, more quickly than the other colored fine grain particles, the color of the suspension may change. This color change may be used to indicate the passage of time.

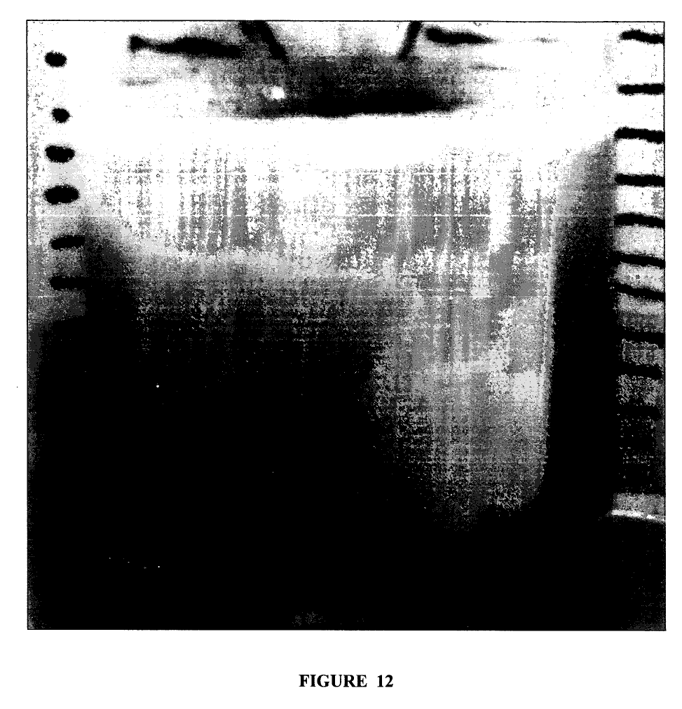

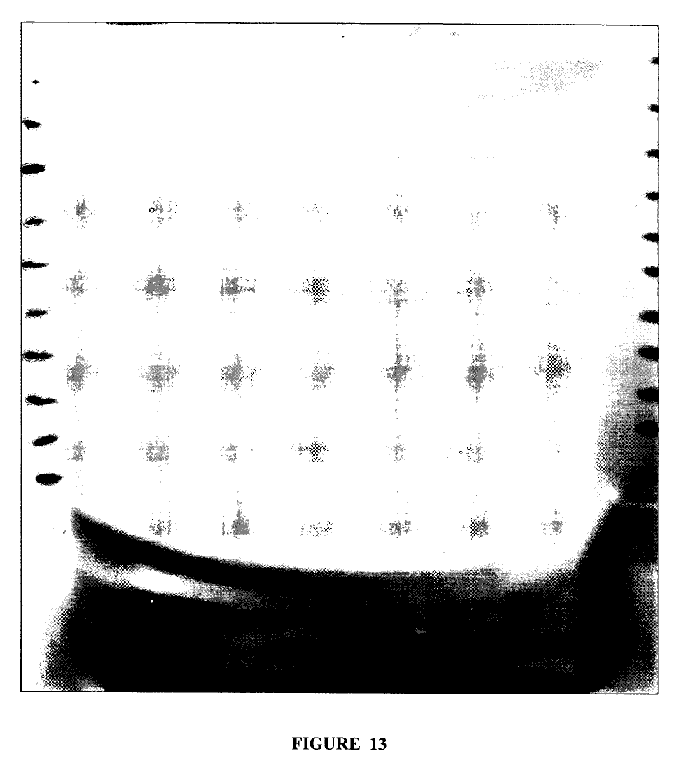

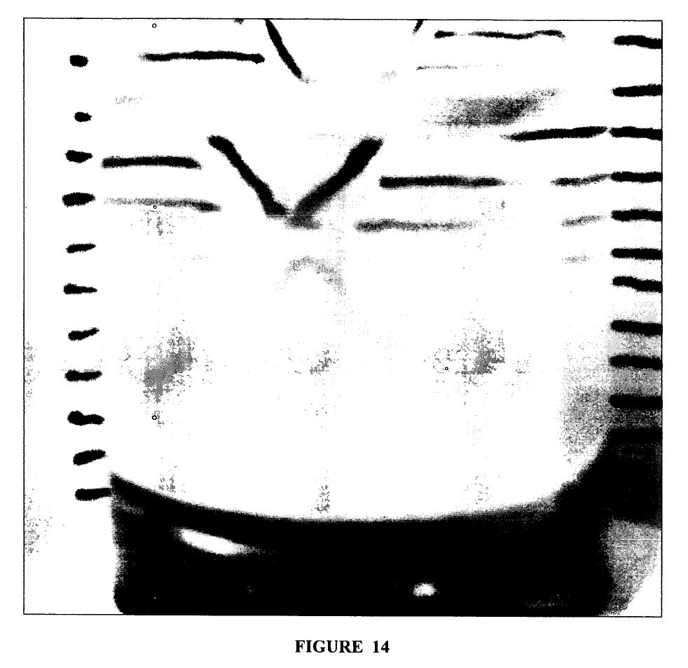

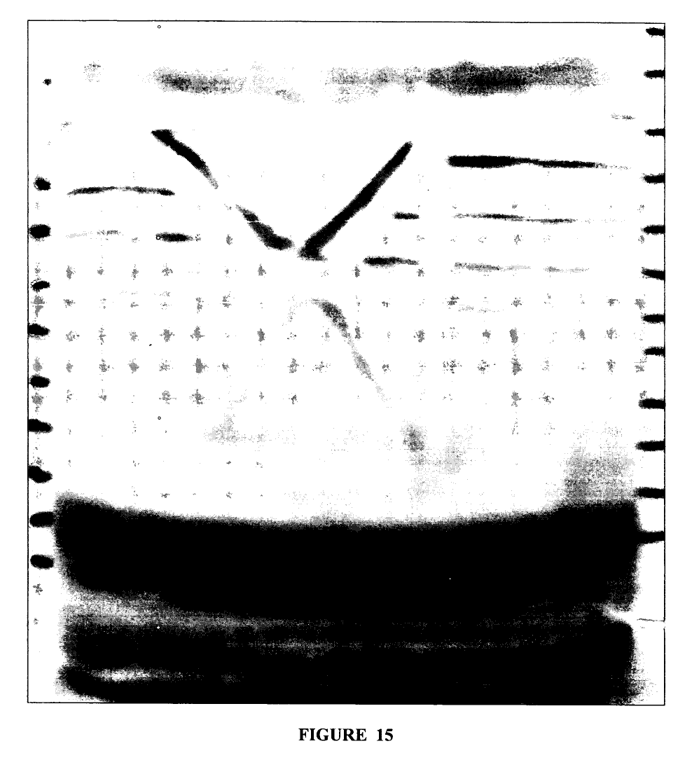

FIGS. 12-15 are photographs of a particle based timing indicator according to some embodiments of the present invention. FIG. 12 is a photograph of a particle based time indicator according to some embodiments of the present invention. FIG. 12 is a photograph of the timing indicator 0.1 hours after it had been activated by turning it over and then resetting it on its bottom surface. The timing marks are obscured by the suspended particles. FIG. 13 is a photograph of the same timing indicator two hours after it had been activated. The timing marks are just coming into view. FIG. 14 is a photograph of the same timing indicator 3 hours after it had been activated. The particle have settled and more timing marks are now visible, indicating that more time has passed since the activation of the timing indicator. FIG. 15 is a photograph of the same timing indicator 8 hours after it had been activated. Even more timing marks are now visible, and the solution is more settled. The passage of time has been indicated by the settling of particles in the solution referenced against the timing marks on the container.

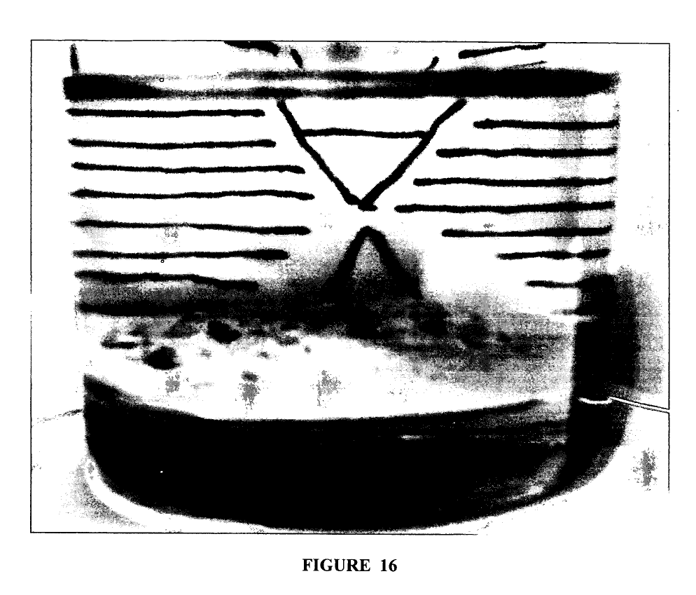

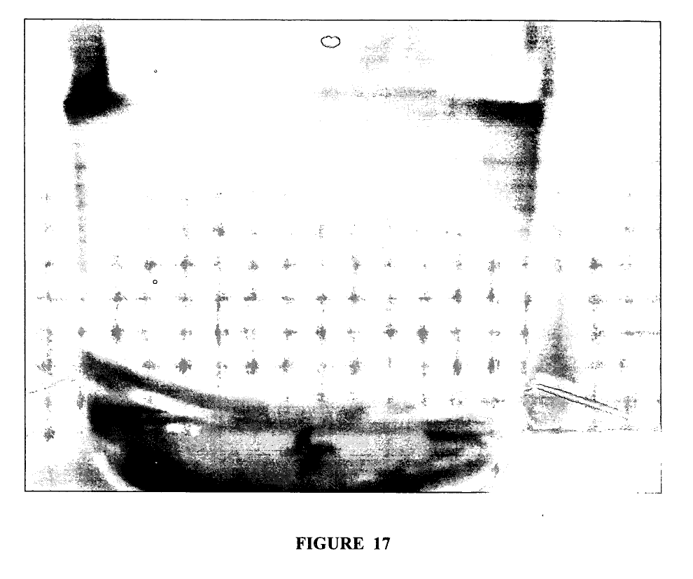

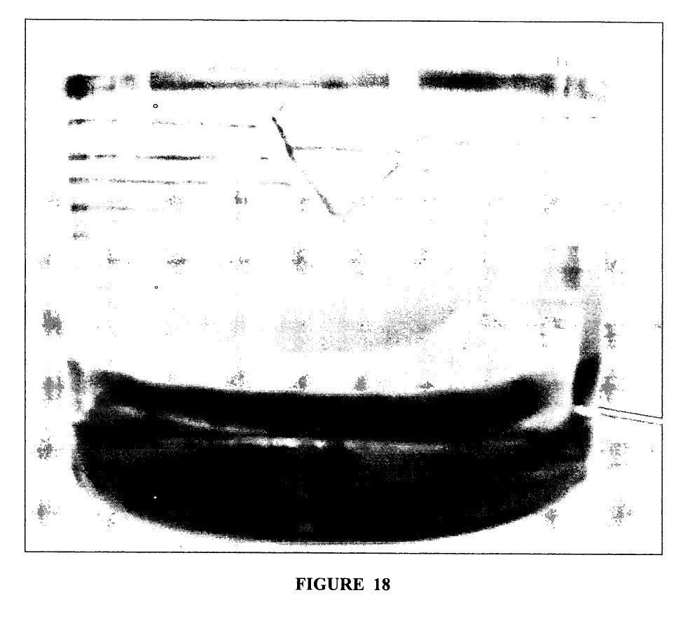

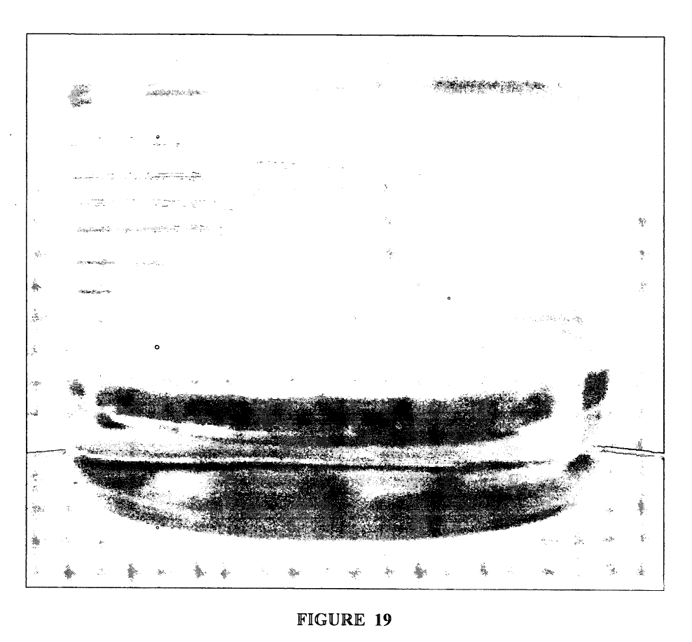

FIGS. 16-19 are photographs of a particle based timing indicator with a different settling rate according to some embodiments of the present invention. FIG. 16 is a photograph of a particle based time indicator according to some embodiments of the present invention. Particle of different sizes are seen in the bottom of the container. A quantity of fine particles is seen along with some much larger particles. Timing marks are seen through the fluid, as the time indicator has not been activated and the particles are fully settled. FIG. 17 is a photograph of the same timing indicator two hours after it had been activated by turning it over and then resetting it on its bottom surface. The timing marks are obscured by the suspended particles. The upper timing marks are just coming into view. FIG. 18 is a photograph of the same timing indicator five hours after it had been activated. The particle have substantially settled and more timing marks are now visible, indicating that more time has passed since the activation of the timing indicator. FIG. 19 is a photograph of the same timing indicator 8 hours after it had been activated. Even more timing marks are now visible, and the solution is now nearly fully settled. The passage of time has been indicated by the settling of particles in the solution referenced against the timing marks on the container.

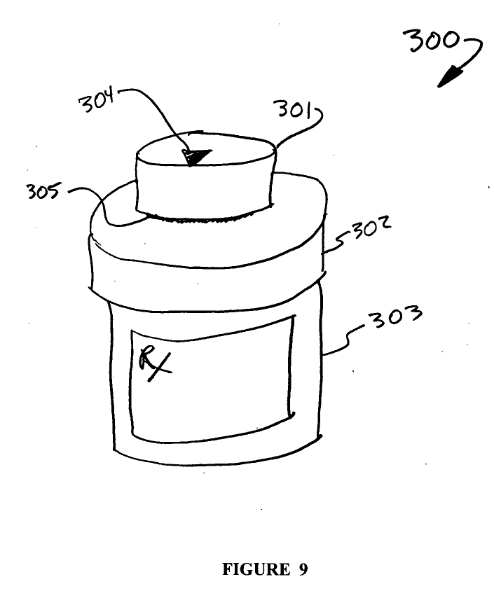

FIG. 9 illustrates an embodiment 300 including a medicine container 303, such as a prescription bottle, with its lid 302. The medicine container 303 and the lid 302 may be a standard prescription bottle in some embodiments. A particle-based time indicator 301 is affixed to the top of the lid 302. In some embodiments, the particle-based time indicator 301 is affixed with an attachment portion 305. In some embodiments, the attachment portion 305 is a hook and loop fastening element. In some embodiments, the attachment portion 305 is a piece of double backed tape. In some embodiments, the attachment portion 305 is another type of appropriate fastener. When the lid 302 is removed from the container 303 in order to remove a pill, the time indicator 301 is disturbed. Typically, the disturbance will be sufficient that the particles in the indicator 301 will be suspended and the indicator is triggered. The indicator 301 now gives a measure of the elapsed time since the medication in the container was last accessed. A viewing marker 304 may indicate at which point the viewer should look in through to observe the time indication.

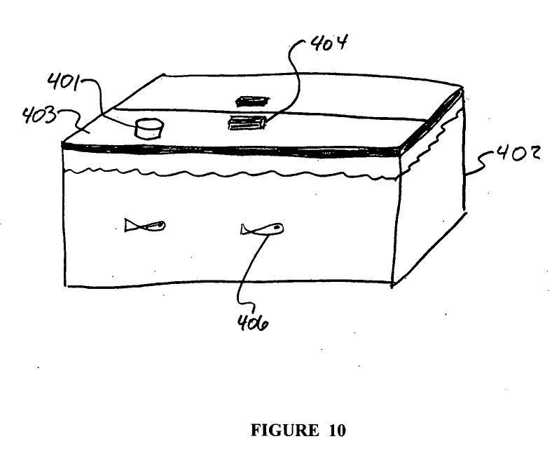

FIG. 10 illustrates another use for a particle-based time indicator 401. A common fish aquarium 402 typically has a two part cover. Part of the cover 403 is raised by a handle 404 in order to feed the fish 406. Often one forgets when one has last fed the fish. By placing a time indicator 401 on the cover 403, when the cover is lifted to feed the fish the indicator will be triggered and the particles will be suspended. This will then allow the user to see when the fish were last fed and to feed the fish again at an appropriate interval.

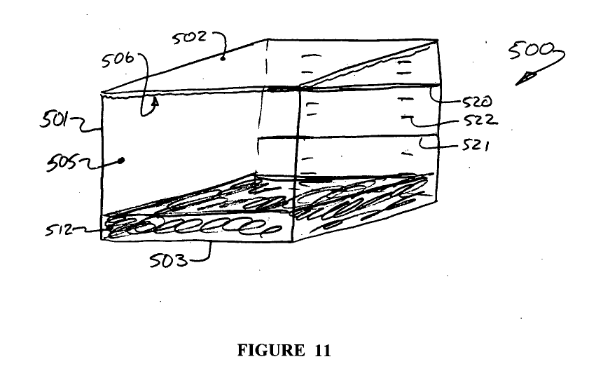

FIG. 11 illustrates a particle-based timing indicator 500 according to some embodiments of the present invention. A particle-based timing apparatus 500 has an enclosed container 501 containing a volume of fluid 505. In some embodiments, the fluid is isopropyl alcohol. The enclosed container 501 has a top 502 and a bottom 503. The volume of fluid 505 has a top surface 506 which leaves a small air space in some embodiments. Within the enclosed container 501 are a volume of particles 512. In some embodiments, the volume of particles 512 consists of a volume of a first size range of particles, and a volume of a second size range of particles. In some embodiments, the first size range of particles is a larger size range consisting of particles of approximately 0.050 to 0.010 inches in cross section. The second size range of particles may consist of fine grain particles of much smaller size. In some embodiments, the timing indicator 500 may have a one or more timing marks 520, 521, 522 for use in measuring and indicating the passage of time. In some embodiments, the timing marks are meant to be viewed through the fluid. In some embodiments, the timing marks may not be visible from the outside of the container on the face upon which they reside, but are visually blocked to require viewing through the fluid.

As evident from the above description, a wide variety of embodiments may be configured from the description given herein and additional advantages and modifications will readily occur to those skilled in the art. The invention in its broader aspects is, therefore, not limited to the specific details and illustrative examples shown and described. Accordingly, departures from such details may be made without departing from the spirit or scope of the applicant's general invention.

I claim:

1. A particle based timing apparatus, said apparatus comprising:
an enclosed container, said container of a first volume;
a volume of fluid contained in said enclosed container; and
a volume of particles contained in said container.

2. The apparatus of claim 1 wherein said volume of fluid substantially fills said first volume.

3. The apparatus of claim 1 wherein said volume of particles comprises:
a first volume of a first size range of particles; and
a second volume of a second size range of particles.

4. The apparatus of claim 3 wherein said second size range of particles is larger than said first size range of particles.

5. The apparatus of claim 4 wherein said second size range of particles is a range wherein said particles are of a size such that they settle out of the liquid substantially immediately.

6. The apparatus of claim 3 wherein said enclosed container comprises a timing mark.

7. The apparatus of claim 3 wherein said enclosed container comprises a plurality of timing marks.

8. The apparatus of claim 7 wherein said enclosed container further comprises a top and a bottom, and wherein said plurality of timing marks are distributed along a direction from said top to said bottom on said enclosed container.

9. The apparatus of claim 8 wherein said plurality of timing marks are adapted to be viewed through said volume of fluid.

10. The apparatus of claim 7 wherein said enclosed container is substantially cylindrical.

11. The apparatus of claim 6 wherein said volume of liquid comprises isopropyl alcohol.

12. An apparatus comprising:
a container, said container adapted for the storage of medication;
a lid, said lid adapted to be secured to said container; and
a timing portion, said timing portion affixed to said lid.

13. The apparatus of claim 12 wherein said timing portion comprises:
an enclosed container, said container of a first volume;
a volume of fluid contained in said enclosed container; and
a volume of particles contained in said container.

14. The apparatus of claim 13 wherein said volume of particles comprises:
a first volume of a first size range of particles; and
a second volume of a second size range of particles.

15. The apparatus of claim 14 wherein said second size range of particles is larger than said first size range of particles.

16. The apparatus of claim 15 wherein said second size range of particles is a range wherein said particles are of a size such that they settle out of the liquid substantially immediately.

17. The apparatus of claim 14 wherein said enclosed container comprises a timing mark.

18. The apparatus of claim 14 wherein said enclosed container comprises a plurality of timing marks.

19. The apparatus of claim 18 wherein said enclosed container further comprises a top and a bottom, and wherein said plurality of timing marks are distributed along a direction from said top to said bottom on said enclosed container.

20. The apparatus of claim 19 wherein said plurality of timing marks are adapted to be viewed through said volume of fluid.

21. A method for timing, said method comprising:
suspending particles in a fluid by upsetting a fluid and particle filled container;
setting the container on its bottom surface; and
viewing timing marks through the liquid in the container.

22. The method of claim 21 further comprising allowing the passage of time during which said timing marks become visible through the liquid.

23. The method of claim 22 further comprising imputing a time based on the visibility of said timing marks.

24. The method of claim 21 wherein said suspending particles in a fluid comprises suspending fine particles in part by the stirring motion of larger particles.
